(19) United States
(12) Patent Application Publication
(10) Pub. No.: US 2014/0053631 A1
(43) Pub. Date: Feb. 27, 2014

(54) GAS DETECTION APPARATUS AND GAS DETECTION METHOD

(71) Applicant: NGK Spark Plug Co., Ltd., Nagoya-shi (JP)

(72) Inventors: Masaya WATANABE, Komaki-shi (JP); Shoji KITANOYA, Kasugai-shi (JP); Daisuke ICHIKAWA, Minokamo-shi (JP); Masahiro YAMASHITA, Komaki-shi (JP)

(73) Assignee: NGK Spark Plug Co., Ltd., Nagoya-shi (JP)

(21) Appl. No.: 13/973,047

(22) Filed: Aug. 22, 2013

(30) Foreign Application Priority Data
Aug. 22, 2012 (JP) 2012-183405

(51) Int. Cl. G01N 9/36

(52) U.S. Cl. CPC G01N 9/36
USPC 73/30.01

(57) ABSTRACT

A gas detection apparatus includes: a heating resistor; and an energization control unit which alternately switches a temperature of the heating resistor to two different temperatures. The gas detection apparatus calculates a density of combustible gas contained in the atmosphere using a heating resistor voltage in a high temperature period and a heating resistor voltage in a low temperature period; acquires three or more values of the heating resistor voltage in each target period; obtains a first average value of the values of the heating resistor voltage obtained in the target period of the high temperature period; obtains a second average value of the values of the heating resistor voltage obtained in the target period of the low temperature period; and uses the first and second average values for a calculation of density of the combustible gas.

### BACKGROUND

The present invention relates to a gas detection apparatus and a gas detection method which are used in density measurement or leakage detection of combustible gas.

In recent years, according to the social demands such as environmental protection or nature conservation or the like, research on fuel cells has been actively performed as an energy source which has a high efficiency and has less impact on the environment. Among the fuel cells, a polymer electrolyte fuel cell (PEFC) receives attentions as an energy source for home or an energy source for automobiles because of benefits of low operating temperature and high power density and the like. The polymer electrolyte fuel cell uses hydrogen in which leakage is more likely to occur in comparison with other fuels. For this reason, a gas detector which can detect the hydrogen leakage is considered to be necessary in order to commercialize the polymer electrolyte fuel cell.

In addition, in the same manner as the polymer electrolyte fuel cell, research on hydrogen internal combustion engines which use hydrogen as a fuel, that is, an energy source which has less impact on the environment. With regard to the hydrogen internal combustion engine, a gas detector detecting the hydrogen leakage is considered to be necessary in order to commercialize the same.

In the past, a gas detection apparatus which detects the density of the specific combustible gas contained in an atmosphere (subjected to the detection) using thermal conductivity of the atmosphere (e.g., refer to Japanese Patent No. 4165300) is known. In the gas detection apparatus, values of the current to be supplied to a heating resistor of the gas detection apparatus are changed in at least three or more stages in a stepwise manner and the respective values of the current are continuously held for a specified period of time. Then, the density of the specific combustible gas contained in the atmosphere from the measured value is detected by heating resistor voltage between terminals of the heating resistor with respect to respective current values after a specified time elapses.

### SUMMARY

In order to increase detection accuracy of a specific combustible gas density by the above-described gas detection apparatus, it is necessary to stabilize the heating resistor voltages of the heating resistor and then acquire the heating resistor voltage. However, if the current values to be supplied to the heating resistor are changed in a stepwise manner, in a little while thereafter, the values of the heating resistor voltage greatly fluctuate and become unstable regardless of the specific combustible gas density. As a result, it is difficult to increase the detection accuracy of the specific combustible gas density.

In addition, in a case where noise is generated during the measurement of the heating resistor voltage, since the heating resistor voltage greatly fluctuate regardless of the specific combustible gas density, there is a problem in that the detection accuracy of the combustible gas density decreases.

The present invention is made to solve the above disadvantages and aims to provide a gas detection apparatus and a gas detection method which can further increase the detection accuracy of the specific gas density.

An aspect of the present invention provides the following arrangements:
(1) A gas detection apparatus comprising:

a heating resistor which is disposed in an atmosphere and of which a resistance value changes due to change in temperature of the heating resistor;

an energization control unit which alternately switches, by controlling switching an energization state to the heating resistor at a predetermined cycle, a temperature of the heating resistor to two different temperatures of a high temperature side and a low temperature side which are set in advance; and

an operating unit which:

calculates a density of combustible gas contained in the atmosphere using a heating resistor voltage between terminals of the heating resistor in a high temperature period which is controlled to the high temperature side and a heating resistor voltage between terminals of the heating resistor in a low temperature period which is controlled to the low temperature side;

acquires three or more values of the heating resistor voltage in each target period after a predetermined waiting time elapses since the energization control unit switches each period of the high temperature period and the low temperature period, the three or more values of the heating resistor voltage are acquired at an interval shorter than the target period;

obtains a first average value of the values, from which a maximum value and a minimum value are excluded, of the heating resistor voltage obtained in the target period of the high temperature period;

obtains a second average value of the values, from which a maximum value and a minimum value are excluded, of the heating resistor voltage obtained in the target period of the low temperature period; and

uses the first and second average values for a calculation of density of the combustible gas.
(2) The gas detection apparatus according to (1), wherein

four or more values of the heating resistor voltage are acquired in the target period of the high temperature period, and

four or more values of the heating resistor voltage are acquired in the target period of the low temperature period respectively.
(3) The gas detection apparatus according to (1) or (2), further comprising a temperature measuring resistor of which a resistance value changes according to changes of an environmental temperature which is a temperature of the atmosphere,

wherein the operating unit:

calculates the density of the combustible gas based on the environmental temperature, which is obtained from the resistance value of the temperature measuring resistor during the calculation of the density of the combustible gas, and the first and second average values;

acquires three or more values corresponding to the resistance value of the temperature measuring resistor during at least one of the waiting time of the high temperature period and the waiting time of the low temperature period;

obtains a third average value of the values, from which a maximum value and a minimum value are excluded, of the temperature measuring resistor;

sets the third average value corresponding to the resistance value of the temperature measuring resistor which is used for the calculation of the density of the combustible gas.
(4) A gas detection method in which a gas detection apparatus including a heating resistor which is disposed in an atmosphere and of which a resistance value changes due to change in temperature of the heating resistor is used, the method comprising:

alternately switching, by controlling switching an energization state to the heating resistor at a predetermined cycle, a temperature of the heating resistor to two different temperatures of a high temperature side and a low temperature side which are set in advance:

calculating a density of combustible gas contained in the atmosphere using heating resistor voltage between terminals of the heating resistor in a high temperature period which is controlled to the high temperature side and a heating resistor voltage between terminals of the heating resistor in a low temperature period which is controlled to the low temperature side;

acquiring three or more values of the heating resistor voltage in each target period after a predetermined waiting time elapses since the energization control unit switches each period of the high temperature period and the low temperature period, the three or more values of the heating resistor voltage are acquired at an interval shorter than the target period; and

obtaining a first average value of the values, from which a maximum value and a minimum value are excluded, of the heating resistor voltage obtained in the target period of the high temperature period;

obtaining a second average value of the values, from which a maximum value and a minimum value are excluded, of the heating resistor voltage obtained in the target period of the low temperature period; and

using the first and second average values for a calculation of density of the combustible gas.
(5) The gas detection method according to (4),

four or more values of the heating resistor voltage are acquired in the target period of the high temperature period, and

four or more values of the heating resistor voltage are acquired in the target period of the low temperature period respectively.
(6) The gas detection method according to (4) or (5), wherein

the density of the combustible gas is calculated based on an environmental temperature, which is obtained from a resistance value of a temperature measuring resistor during the calculation of the density of the combustible gas, and the first and second average values, the resistance value of the temperature measuring resistor changing according to changes of the environmental temperature;

three or more values corresponding to the resistance value of the temperature measuring resistor are acquired during at least one of the waiting time of the high temperature period and the waiting time of the low temperature period;

a third average value of the values, from which a maximum value and a minimum value are excluded, of the temperature measuring resistor is obtained;

the third average value is set corresponding to the resistance value of the temperature measuring resistor which is used for the calculation of the density of the combustible gas.

### BRIEF DESCRIPTION OF THE DRAWINGS

FIG. 1 is an explanatory view illustrating an overall configuration of a combustible gas detection apparatus according to an embodiment of the present invention.

FIG. 2A is a plan view illustrating a configuration of a gas detection element of the combustible gas detection apparatus and FIG. 2B is explanatory view illustrating a cross-section A-A of FIG. 2A.

FIG. 3A is a graph illustrating a time change of heating resistor voltage between terminals of a heating resistor and FIG. 3B is a graph illustrating the time change of the humidity of the heating resistor.

FIG. 4 is an explanatory view illustrating a change in a high temperature period and a low temperature period of the heating resistor voltages and timing of acquiring data.

FIG. 5 is a flow chart illustrating a part of a calculation data acquisition process in the operating unit.

FIG. 6 is a flow chart illustrating a part of the calculation data acquisition process in the operating unit.

FIG. 7 is a flow chart illustrating a gas density calculation process in the operating unit.

FIG. 8A is a graph illustrating a relation between ΔVH (H) and humidity in a case where there is no multiple and FIG. 8B is a relation between the ΔVH (H) and the humidity in a case where there is a multiple.

### DESCRIPTION OF EXEMPLARY EMBODIMENTS

Hereinafter, an embodiment of a gas detection apparatus and a gas detection method of the present invention will be described.

Here, description will be made by taking a combustible gas detection apparatus (hereinafter, simply referred to as gas detection apparatus) and a combustible gas detection method (hereinafter, simply referred to as gas detection method) which detect the density of hydrogen gas as combustible gas as examples.

### Embodiment

A gas detection apparatus of the present embodiment is a heat-conductive gas detection apparatus which detects the density of hydrogen gas, which is combustible gas contained in an atmosphere (subject to the detection). In addition, a gas detection method of the present embodiment is a method of detecting the density of the hydrogen gas using the gas detection apparatus. These are installed, for example, in a room of fuel cell vehicles and used for purposes such as detecting leakage of hydrogen and the like.

a) First, a configuration of the gas detection apparatus of the present embodiment will be described.

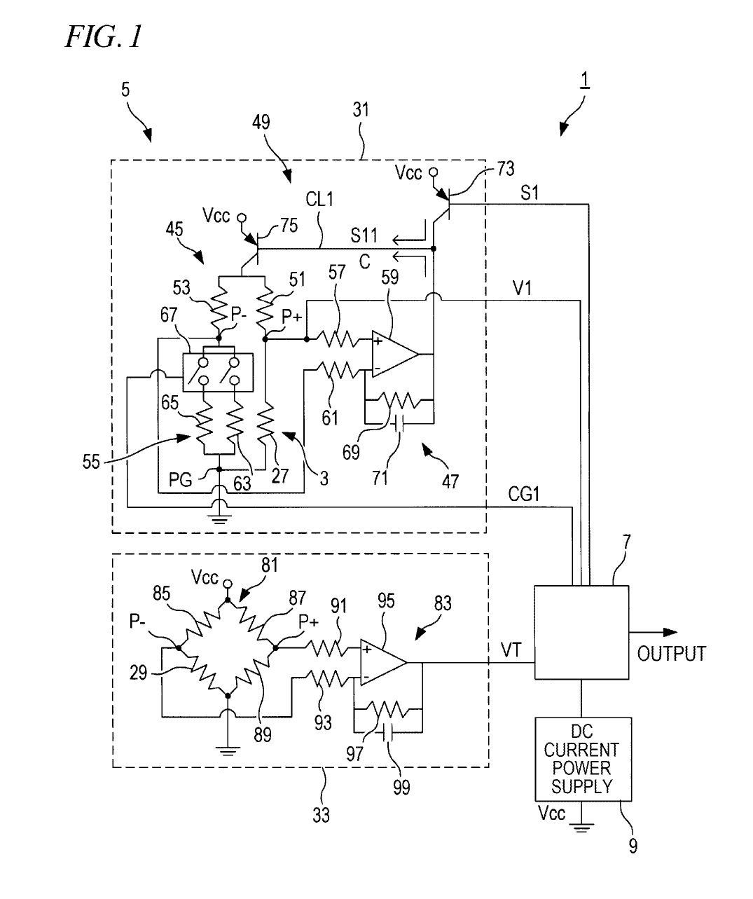

As illustrated in FIG. 1, a gas detection apparatus 1 of the present embodiment, primarily, includes a gas detection element 3 detecting the density of the hydrogen gas, a control unit 5 controlling the operation of the gas detection element 3, an operating unit 7 calculating the hydrogen gas density based on output signals of the gas detection element 3, and a DC power supply 9 supplying power to the control unit 5 and the operating unit 7.

Hereinafter, description will be given with regard to each configuration.

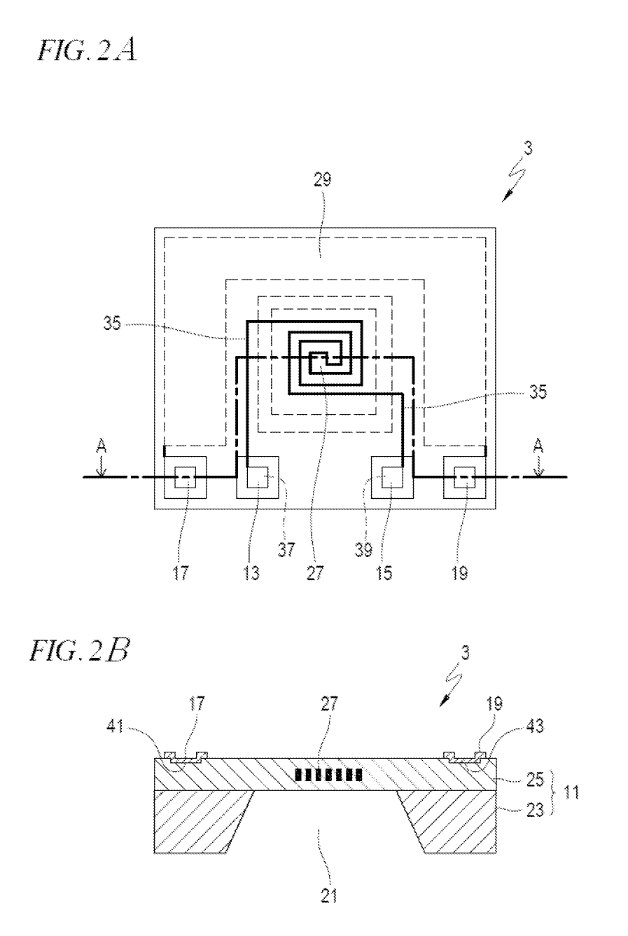

As illustrated in FIG. 2, the gas detection element 3, primarily, includes a base portion 11 formed into a plate shape and a plurality of electrodes 13, 15, 17, and 19, or the like disposed on a surface of the base portion 11(upper side of FIG. 2B). In addition, the gas detection element 3 is an element in which a concave portion 21 is formed on a back surface (lower side of FIG. 2B) of the base portion 11 and the back surface in which the concave portion 21 is formed is disposed in a state of being exposed to the atmosphere.

Of these, the base portion 11 configures a main body of the gas detection element 3, for example, is a rectangular plate member formed into a size of several mm both vertically and horizontally, and is configured of a silicon substrate 23 and a insulating layer 25 formed on a surface of the silicon substrate 23.

The substantially square-shaped concave portion 21 in which the silicon substrate 23 is removed in a plan view is formed in the center of the back surface of the silicon substrate 23 and the insulating layer 25 is exposed at the bottom of the concave portion 21. Therefore, a diaphragm structure forming the insulating layer 25 into a thin film is formed in the base portion 11

A linear heating resistor 27 is embedded in a region corresponding to the concave portion 21 in the insulating layer 25, that is, in a region of configuring the bottom surface of the concave portion 21 in a spiral shape. In addition, one temperature measuring resistor 29 measuring the temperature of the atmosphere is embedded in the three sides (upper side, left side, and right side of FIG. 1A) in the insulating layer 25 in a U-shape in plan view.

In this manner, the concave portion 21 is formed, and the heating resistor 27 is thermally insulated from the surrounding by forming a space at the lower side of the insulating layer 25 where the heating resistor 27 is provided. Therefore, it is possible to perform heating up and cooling down in a short time and to reduce the power consumption of the heating resistor 27.

Moreover, the insulating layer 25 may be formed of a single material and may be formed so as to form multiple layers using different materials. In addition, as an insulating material configuring the insulating layer 25, for example, there may be silicon oxide (SiO₂) and silicon nitride (Si₃N₄)

The heating resistor 27 is a material of which a resistance value is changed due to its own temperature change and is formed of a conductive material having a large temperature resistance coefficient. On the other hand, the temperature measuring resistor 29 is formed of a conductive material in which an electrical resistance changes in proportion to a temperature. In the present embodiment, the temperature measuring resistor is formed of a conductive material in which the resistance value increases as the temperature increases. Moreover, the heating resistor 27 and the temperature measuring resistor 29 may be configured of the same material. In the embodiment, the heating resistor 27 and the temperature measuring resistor 29 are configured of platinum (pt).

A potential difference based on the changes in the above-described resistance value is amplified and then is output as the temperature detection signal VT, which will be described later, in the temperature measuring resistor 29. In the present embodiment, the temperature detection signal VT which is output from the temperature measuring resistor 29 serves as a reference value, which is a predetermined potential difference, when the temperature of the atmosphere in which the gas detection element 3 is exposed is a pre-set reference temperature.

Electrodes 13 to 19 are the electrodes formed in the vicinity of one side (lower side of FIG. 2A) of the surface of the base portion 11, in which the temperature measuring resistor 29 is not formed, and for example, are formed using aluminum (Al) or gold (Au). Of the electrodes 13 to 19, two electrodes in the center are a measuring electrode (first electrode 13) for the heating resistor and a ground electrode (first ground electrode 15) for the heating resistor. Furthermore, two electrodes on the outside are a measuring electrode (second electrode 17) for the temperature measuring resistor and a ground electrode (second ground electrode 19) for the temperature measuring resistor.

Moreover, the first electrode 13 is connected to a connection point P+ of an energization control circuit 31 (refer to FIG. 1) which will be described later and the second electrode 17 is connected to a connection point p− of a temperature control unit 33 (refer to FIG. 1) which will be described later. The first ground electrode 15 and the second ground electrode 19 are connected to the control unit 5 and a common ground line.

In addition, a wire 35 and wiring films 37 and 39 are provided in the interior of the base portion 11, more specifically, in the interior of the insulating layer 25. The wire 35 and the wiring films 37 and 39 electrically connect the heating resistor 27 to the first electrode 13 and the first ground electrode 15. The first electrode 13 and the first ground electrode 15 on the surface of the base portion 11 are electrically connected to the wiring films 37 and 39 of the interior of the insulating layer 25 by a contact hole having conductivity. In other words, the heating resistor 27 is conductively connected to the first electrode 13 at one end and is conductively connected to the first ground electrode 15 at the other end.

Furthermore, wiring films 41 and 43 which electrically connect the temperature measuring resistor 29 to the second electrode 17 and the second ground electrode 19 are provided in the interior of the insulating layer 25. In other words, the temperature measuring resistor 29 is conductively connected to the second electrode 17 at one end and is conductively connected to the second ground electrode 19 at the other end. Moreover, as a material configuring the wire 35 and wiring films 37, 39, 41, and 43, it is possible to use the same material as the material configuring heating resistor 27 and the temperature measuring resistor 29.

Moreover, as a technology configuring a plurality of electrodes 13 to 19 or the concave portion 21 or the like with respect to the base portion 11, a micromachining technique (micromachining process) performed on a silicon substrate can be taken as an example.

Returning to the FIG. 1, the control unit 5 includes the energization control circuit (energization control unit) 31 which performs the energization control to the heating resistor 27 and outputs detection signals V1 corresponding to a voltage (heating resistor voltage) between terminals of the heating resistor 27 and the temperature control unit 33 which performs the energization to the temperature measuring resistor 29 and outputs temperature detection signals VT (also referred to as temperature voltage VT) according to the temperature of the atmosphere.

The energization control circuit 31 (energization control unit) is a circuit maintaining the temperature of the heating resistor 27 at a constant temperature. In addition, a bridge circuit 45, which is a Wheatstone bridge circuit including the heating resistor 27, an amplifying circuit 47 amplifying a potential difference detected by the bridge circuit 45, and a current adjusting circuit 49 adjusting the increase and decrease of the current flowing through the bridge circuit 45 according to the output of the amplifying circuit 47 are included in the energization control circuit 31.

The bridge circuit 45 includes the heating resistor 27, two of a first bridge fixed resistance 51 and a second bridge fixed resistance 53, and a variable resistance unit 55 which can switch a resistance value. A first bridge fixed resistance 51 is connected in series to the heating resistor 27, an end portion PG of the heating resistor 27 of the first bridge fixed resistance 51 is grounded, and an end portion of the second bridge fixed resistance 53 is connected to the current adjusting circuit 49, which is a power supply. In addition, the second bridge fixed resistance 53 is connected in series to the variable resistance unit 55, an end portion PG of the variable resistance unit 55 of the second bridge fixed resistance 53 is grounded, and an end portion of the first bridge fixed resistance 51 is connected to the current adjusting circuit 49, which is the power supply.

The connection point P+ of the first bridge fixed resistance 51 and the heating resistor 27 is connected to a non-inverting input terminal of an operational amplifier 59 via the first fixed resistance 57. A potential of the connection point P+ is supplied to the operating unit 7 as a detection signal V1. In addition, the connection point P− of the second bridge fixed resistance 53 and the variable resistance unit 55 is connected to the inverting input terminal of the operational amplifier 59 via the second fixed resistance 61.

The variable resistance unit 55 switches the balance of the bridge circuit 45 by switching the resistance value. In addition, two of the first fixed resistance 63 and the second fixed resistance 65 which have different resistance values, and a switch 67 which effectively operates either the first fixed resistance 63 or the second fixed resistance 65 are provided in the variable resistance unit 55. The switch 67 performs the switching operation according to a switching signals CG1 output from the operating unit 7.

Moreover, the first fixed resistance 63 has a resistance value in which the heating resistor 27 becomes a first set temperature CH (e.g., 400° C.) of the high temperature side. In addition, the second fixed resistance 65 has a resistance value in which the heating resistor 27 becomes a second set temperature CL (e.g., 300° C.) of the low temperature side set lower than the first set temperature CH.

The amplifying circuit 47 is a differential amplifying circuit and is a widely-known circuit configured of the operational amplifier 59, the first fixed resistance 57 and the second fixed resistance 61 which are respectively connected to the inverting input terminal and the non-inverting input terminal of the operational amplifier 59, and a third fixed resistance 69 and a capacitor 71 which are connected in parallel between the output terminal and the inverting input terminal of the operational amplifier 59.

A value of an adjustment signal C, which is an output, of the amplifying circuit 47 increases in a case where an input voltage of the non-inverting input terminal is larger than an input voltage of the inverting input terminal. As a result, the current flowing through the bridge circuit 45 is decreased. Conversely, the value of the adjustment signal C is decreased in a case where the input voltage of the non-inverting input terminal is smaller than the input voltage of the inverting input terminal. As a result, the current flowing through the bridge circuit 45 is increased.

The switching circuit 73 of the current adjusting circuit 49 is connected to a power supply line supplying DC power Vcc to the bridge circuit 45 and a control line CL1 which changes an energization state of the current adjusting circuit 49. In addition, the switching circuit 73 is configured to have a transistor which performs ON/OFF operations according to the operation permission signal S1 from the operating unit 7 and is configured so as to output a start signal S11 to the control line CL1 for a predetermined period of time when the transistor is turned on. Moreover, the predetermined period of time when the transistor is turned on is set in advance so as not to interfere with the output of the adjustment signal C which will be described later.

The current adjusting circuit 75 of the current adjusting circuit 49 is connected to the power supply line and the bridge circuit 45 and is configured of a transistor in which the energization state (on-resistance) is changed according to the signals flowing through the control line CL1. Specifically, the current adjusting circuit 75 starts the current supply to the bridge circuit 45 according to the start signal S11, which is the output of the switching circuit 73. Then, when the current supply to the bridge circuit 45 is started, according to the adjustment signal C, which is the output of the amplifying circuit 47, as the adjustment signal C becomes larger, the on-resistance is increased, and as a result, the current flowing through the bridge circuit 45 is decreased. Conversely, as the adjustment signal C becomes smaller, the on-resistance is decreased, and as a result, the current flowing through the bridge circuit 45 is configured so as to increase.

In the energization control circuit 31 having the above-described configuration, when the energization from the DC power supply 9 to the bridge circuit 45 is started, the amplifying circuit 47 and the current adjusting circuit 49 adjust the current flowing through the bridge circuit 45 so that a potential difference occurring between the connection point P+ and the connection point P− becomes zero. Therefore, the resistance value of the heating resistor 27, in other words, the temperature of the heating resistor 27 is controlled to a constant value determined by the variable resistance unit 55, and that is, is controlled to the first set temperature CH and the second set temperature CL.

Specifically, in a case where a heat quantity drawn by the combustible gas from the heating resistor 27 is larger than a heat quantity generated in the heating resistor 27 due to the change of the content of the combustible gas in the atmosphere, the temperature of the heating resistor 27 is lowered and the resistance value of the heating resistor 27 is decreased. Conversely, in a case where the heat quantity drawn by the combustible gas from the heating resistor 27 is smaller than the heat quantity generated in the heating resistor 27, the temperature of the heating resistor 27 is raised and the resistance value of the heating resistor 27 is increased.

As described above, if the resistance value of the heating resistor 27 decreases, the amplifying circuit 47 and the current adjusting circuit 49 increase the current flowing through the bridge circuit 45, in other words, the heat quantity generated in the heating resistor 27. Conversely, if the resistance value of the heating resistor 27 increases, the amplifying circuit 47 and the current adjusting circuit 49 decrease the current flowing through the bridge circuit 45, in other words, the heat quantity generated in the heating resistor 27. In this manner, the amplifying circuit 47 and the current adjusting circuit 49 maintain the resistance value of the heating resistor 27, in other words, the temperature of the heating resistor 27 at a constant value.

Then, a heat quantity required to maintain a magnitude of the current flowing through the heating resistor 27, that is, the temperature of the heating resistor 27, that is, the resistance value can be calculated by measuring a detection signal V1 representing a potential of the connection point P+. In other words, the heat quantity drawn by the combustible gas from the heating resistor 27 can be calculated. In addition, since the drawn heat quantity depends on the density of the hydrogen gas, the hydrogen gas density of the combustible gas can be calculated by measuring the detection signal V1.

In addition, a bridge circuit 81, which is a Wheatstone bridge including the temperature measuring resistor 29, and an amplifying circuit 83 that amplifies a potential difference which can be obtained from the bridge circuit 81 are provided in the temperature control unit 33.

The bridge circuit 81 is a circuit configured of the temperature measuring resistor 29, a first bridge fixed resistances 85, a second bridge fixed resistance 87, and a third bridge fixed resistance 89. The first bridge fixed resistance 85 is connected in series to the temperature measuring resistor 29, an end portion of the first bridge fixed resistance 85 at the temperature measuring resistor 29 side is grounded, and an end portion of the first bridge fixed resistance 85 at the second bridge fixed resistance 87 is connected to the power supply. In addition, the second bridge fixed resistance 87 is connected in series to the third bridge fixed resistance 89, an end portion of the second bridge fixed resistance 87 at the third bridge fixed resistance 89 is grounded, and an end portion of the second bridge fixed resistance 87 at the first bridge fixed resistance 85 is connected to the power supply.

The connection point P− of the first bridge fixed resistance 85 and the temperature measuring resistor 29 is connected to the inverting input terminal of the operational amplifier 95 via a second temperature control fixed resistance 93. The connection point P+ of the second bridge fixed resistance 87 and the third bridge fixed resistance 89 is connected to the non-inverting input terminal of the operational amplifier 95 via a first temperature control fixed resistance 91. In addition, the output of the operational amplifier 95 is supplied to the operating unit 7 as the temperature detection signal VT.

The amplifying circuit 83 is a differential amplifying circuit and is a widely-known circuit configured of the operational amplifier 95, the first temperature control fixed resistance 91 and the second temperature control fixed resistance 93 which are respectively connected to the inverting input terminal and the non-inverting input terminal of the operational amplifier 95, a third fixed resistance 97 which is connected in parallel between the inverting input terminal and the output terminal of the operational amplifier 95, and a capacitor 99.

The operating unit 7 is a so-called microcomputer. In addition, a central processing unit (CPU) for performing various types of operating such as gas density operating, a memory unit such as ROM or RAM which store various types of programs causing a CPU to perform various types of operating data, an IO port for inputting and outputting various signals, and a timer for timekeeping, and the like are provided (not shown) in the operating unit 7.

Then, as described below, the hydrogen gas density is calculated in the operating unit 7 based on the temperature detection signal VT output from the temperature control unit 33 and the detection signal V1 (specifically, high temperature voltage VH, which is heating resistor voltage of the high temperature side, and low temperature voltage VL, which is heating resistor voltage of low temperature side) output from the energization control circuit 31. The operating unit 7 starts up when power feeding is started from the DC power supply 9, initializes various parts after startup, and then starts the gas density operating.

In addition, at least temperature conversion data, humidity conversion data, and density conversion data are stored in the memory unit of the operating unit 7. The temperature conversion data represents a correlation between an environmental temperature T of the atmosphere and a temperature voltage VT, which is the above-described temperature detection signal VT. The humidity conversion data represents a correlation between a humidity H within the atmosphere, the high temperature voltage VH, the low temperature voltage VL, and the temperature voltage VT. The density conversion data represents a correlation between the high temperature voltage VH or the low temperature voltage VL and a gas density X of the combustible gas. Moreover, each data is configured of conversion map data or conversion formulas or the like, and is created in advance based on data obtained by experiments or the like.

In addition, voltage conversion ratio map data representing a correlation between the environmental temperature T (eventually temperature voltage VT) and a voltage ratio VC (0) which will be described later and humidity conversion map data representing a correlation between a voltage ratio difference ΔVC which will be described later and the humidity H is included in the above-described humidity conversion data.

Moreover, voltage conversion map data at high temperature representing a correlation between the temperature voltage VT and the high temperature voltage VH (0) which will be described later, humidity change in voltage conversion map data representing a correlation between the high temperature voltage VH, the humidity H, and a voltage change at high temperature ΔVH (H) which will be described later, and gas sensitivity conversion map data representing a correlation between the temperature voltage VT, the high temperature voltage VH, and a gas sensitivity G (VT) which will be described later are included in the above-described density conversion data.

b) Next, description will be given with regard to main parts of the detection method of the hydrogen gas density by the gas detection apparatus 1 of the present embodiment.

In the present embodiment, as will be described in detail later, the humidity H is calculated in the operating unit 7 based on a relation between the temperature voltage VT obtained from the temperature control unit 33 and the detection signal V1 (specifically, high temperature voltage VH and low temperature voltage VL), which corresponds to the heating resistor voltages of the heating resistor 27 changed in response to thermal conductivity change of the hydrogen gas present in the atmosphere to be measured and is output from the energization control circuit 31.

Then, the hydrogen gas density is calculated using the humidity H obtained by operating, the temperature voltage VT obtained from the temperature control unit 33 and the detection signal V1 (that is, high temperature voltage VH and low temperature voltage VL) output from the energization control circuit 31.

Accordingly, here, description will be given with regard to a setting method of the high temperature voltage VH and the low temperature voltage VL (used in operating of hydrogen gas density), which are main parts of the gas detection method in the present embodiment.

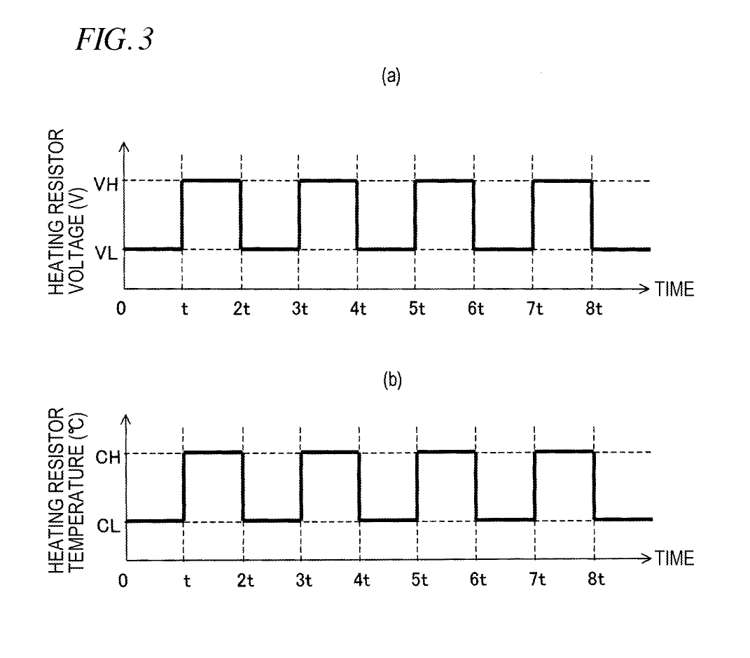

When the hydrogen gas density is detected, as illustrated in FIGS. 3A and 3B, a control process of holding a set temperature of the heating resistor 27 in the second set temperature CL of the low temperature side during the regular cycle time t (hereinafter, referred to as “low-temperature period t”) and a control process of holding the set temperature of the heating resistor 27 in the first set temperature CH of the high temperature side during the regular cycle time t (hereinafter, referred to as “high temperature period t”) are repeatedly performed one after the other in the operating unit 7 of gas detection apparatus 1.

Specifically, the resistance value of the bridge circuit 45, that is, a control process of holding the voltage of the heating resistor 27 in the low temperature voltage VL during the low temperature period t and a control of holding the voltage of the heating resistor 27 in the high temperature voltage VH during the high temperature period t are repeatedly performed alternately by the operating unit 7 outputting a switching signal CG1.

Here, description will be given by adapting an example in which the low temperature period t and the high temperature period t have the same cycle, that is, 200 ms equally. Moreover, it is desirable that a length of 2t which is one cycle of the low temperature period t and the high temperature period t be less than or equal to 5 seconds at the longest. The reason is because a follow-up property of the output with respect to environmental change, in other words, an accuracy of the output becomes worse, if the length of one cycle increases.

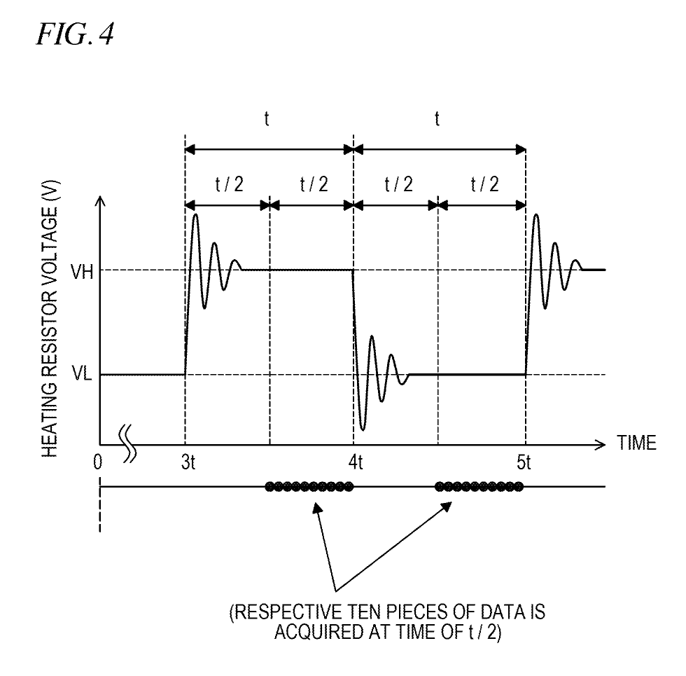

In particular, in the present embodiment, as illustrated in FIG. 4, among the high temperature period t and the low temperature period t, the voltage fluctuation during a predetermined period of time from the switching start to each period t, specifically, the period of 0 to 100 ms, which is a first half period t/2 of each period t, is great and not stable. Thus, the high temperature voltage VH and the low temperature voltage VL are not acquired during the first half period t/2 of each period t.

Then, among the low temperature period t and the high temperature period t, since the voltage during the period of 100 to 200 ms, which is a second half period t/2 (continued in first half period t/2) is stable, the high temperature voltage VH and the low temperature voltage VL are acquired a plurality of times during the second half period t/2. In other words, for example, ten pieces of data are acquired at intervals of 10 ms during the second half period t/2.

Furthermore, during the second half period t/2, when the high temperature voltage VH and the low temperature voltage VL are acquired, there may be a case where the high temperature voltage VH and the low temperature voltage VL fluctuate due to the influence of noise, as described above. Thus, among the data acquired in a plurality of times (here, ten times for each), average values of the data acquired a plurality of times (here, eight), in which the maximum value and the minimum value are removed, are set to the voltage average value at high temperature VHav and the voltage average value at low temperature VLav respectively.

Then, the hydrogen gas density is detected by operating which will be described later using the voltage average value at high temperature VHav and the voltage average value at low temperature VLav which are obtained in this manner.

Moreover, in the present embodiment, description was given by adapting an example in which a length of the switching transition period of the temperature is a half of the low temperature period t or the high temperature period t. However, the length thereof may be a predetermined period longer than a half and may be a predetermined period shorter than a half.

In addition, in the present embodiment, even when the temperature voltage VT is obtained, an averaging process may be performed similar to when the voltage average value at high temperature VHav and the voltage average value at low temperature VLav are obtained.

For example, during the first half period t/2 of the low temperature period t, the data of the temperature voltage VT is acquired a plurality of times (for example, ten times), and among the data, an average value of data acquired a plurality of times (here, eight) may be set to the temperature voltage average value VTav.

c) Next, description will be given with regard to a control process performed in the operating unit 7 in order to detect the hydrogen gas density.

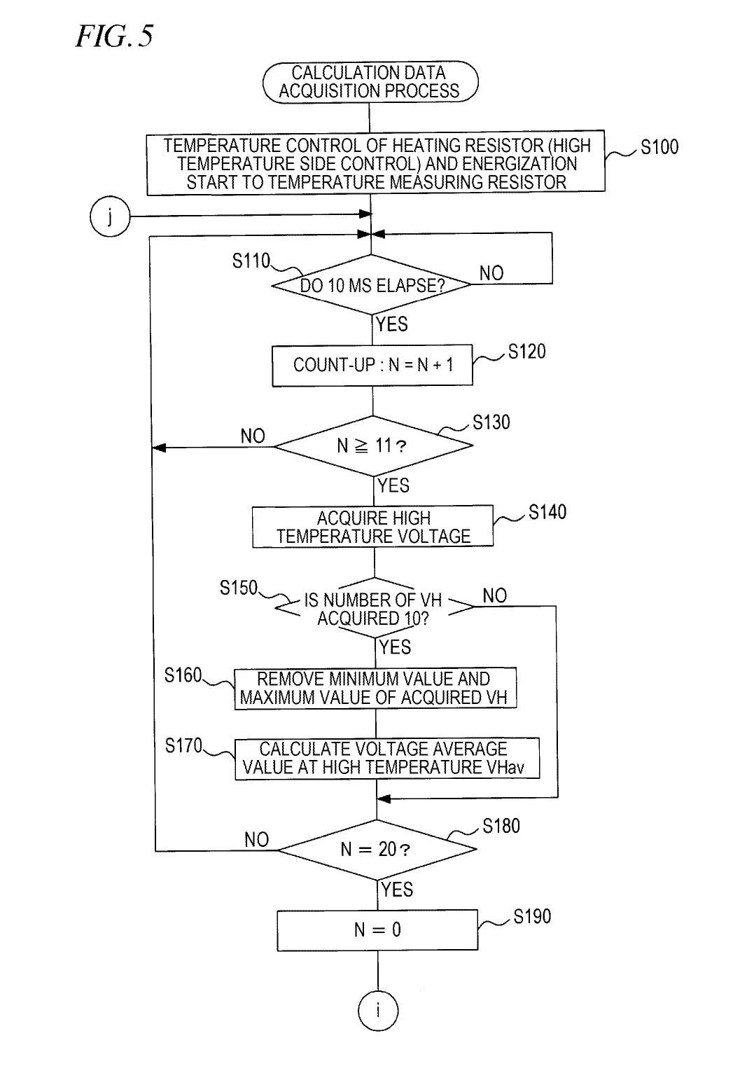

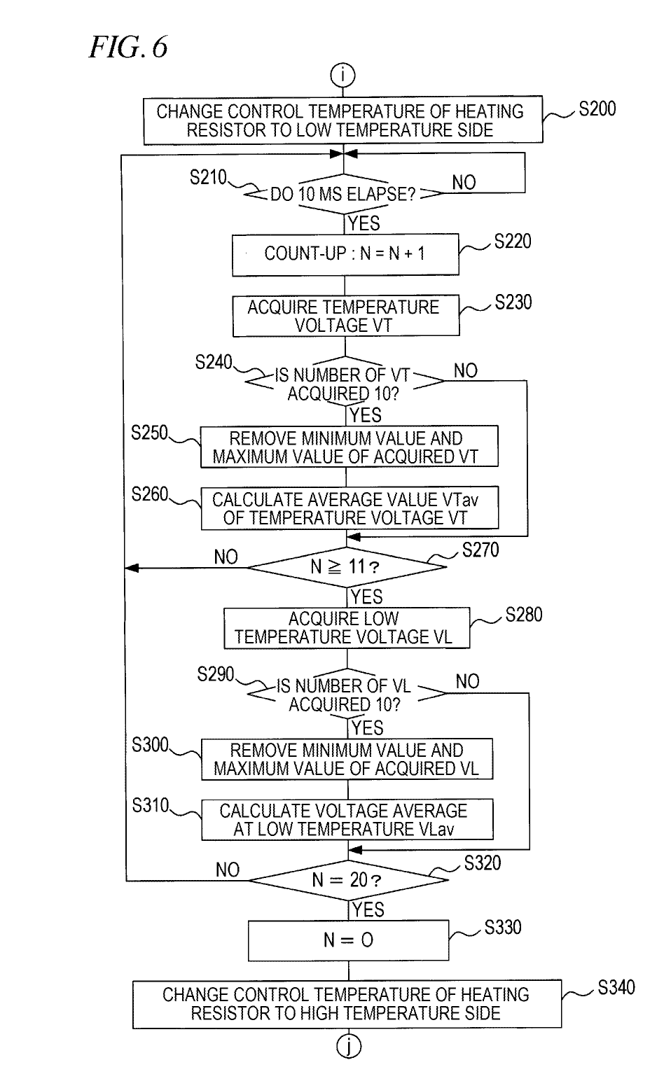

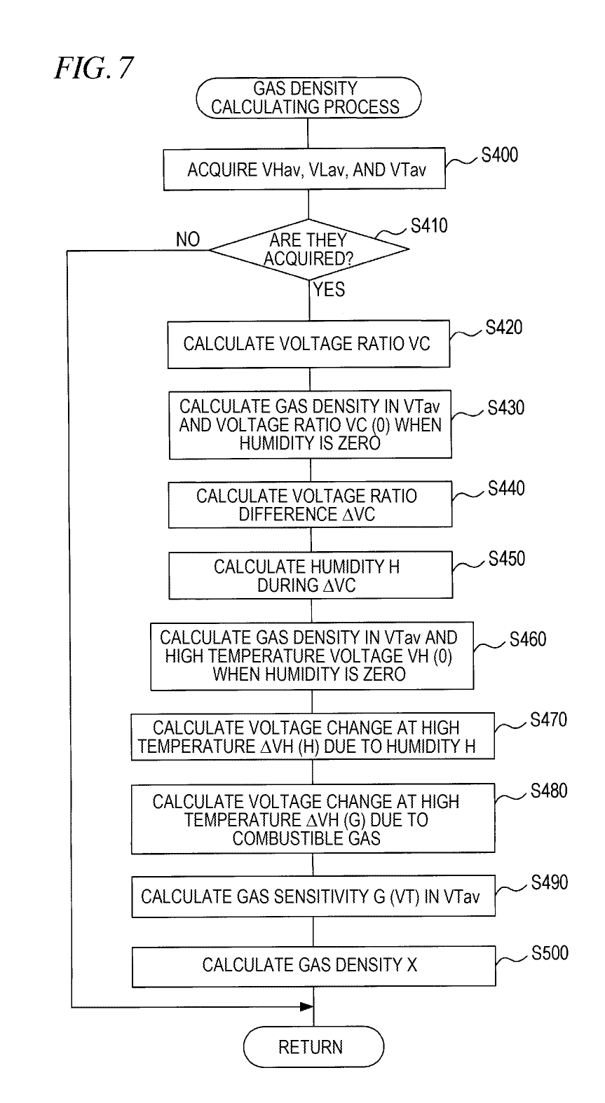

In the operating unit 7, a control process (operating data acquisition process) with regard to a flow chart of FIGS. 5 and 6 and a control process (gas density calculating process) with respect to a flow chart of FIG. 7 are performed at the same time. Here, description will be first given with regard to the calculation data acquisition process of FIGS. 5 and 6 and then the gas density calculating process of FIG. 7 will be described.

Moreover, the calculating process which obtains a gas density X may include the following method. An interim gas density X is obtained using a density conversion data from the low temperature voltage VL or the high temperature voltage VH. The environmental temperature T is obtained using the temperature conversion data from temperature voltage VT. The gas density X is obtained by correcting the resulted interim gas density X using only the resulted environmental temperature T. However, here, the gas density X is obtained using the humidity H in addition to the environmental temperature T.

(Calculation Data Acquisition Process)

The calculation data acquisition process is a process of acquiring various necessary data when the hydrogen gas density is calculated.

As illustrated in FIG. 5, when the control process is started, the temperature of the heating resistor 27 at a high temperature is controlled to be maintained, and at the same time, a control of starting energization to the temperature measuring resistor 29 is conducted (S100). When the control process is started, a counter N which will be described later is set to the value of 0, however, the counter N is counted up every 10 ms. Therefore, it is possible to determine the elapsed time from the start of energization by the value of the counter N. For example, in a case where the value of the counter N is ten, timing from the start of energization to the end (that is, start of second half period t/2) of the first half period t/2 is shown. In addition, in a case where the value of the counter value is 11, for example, timing of the start of the acquisition of the high temperature voltage VH is shown.

Next, it is determined whether or not 10 ms elapse from the start of the previous process (here, process of S100) (S100). Here, in a case where 10 ms does not elapse (in a case of NO), the determination of S110 is repeatedly performed. On the other hand, in a case where it is determined that 10 ms elapsed (in a case of YES), a count-up process of increasing the number of the counter N by one is performed (S120).

Next, it is determined whether or not the value of the counter N is 11 or more (that is, whether or not it is timing of acquisition of high temperature voltage VH) (S130). Here, in a case where the value of the counter N is not 11 or more (in a case of NO), the process returns to S110 and then the same process is repeated. On the other hand, in a case where the value of the counter N is 11 or more (in a case of YES), a process of acquiring and storing the detection signal V1 output from the energization control circuit 31 as the high temperature voltage VH is performed (S140).

Next, it is determined whether or not the number of the acquired voltages VT at high temperature VH, for example, is ten (S150). Here, in a case where the number of the acquired high temperature voltages VH is less than ten (in a case of NO), the process proceeds to S180. On the other hand, in a case where the number of the acquired high temperature voltages VH is ten (in a case of YES), the maximum value and the minimum value (high possibility of noise) are removed from the acquired ten high temperature voltages VH (S160).

Next, the voltage average value at high temperature VHav, which is an average of the eight high temperature voltages VH, in which the maximum value and the minimum value are removed, is calculated and stored (S170).

Next, it is determined whether or not the value of the counter N is 20 (that is, whether or not it is timing of an end of high temperature period t) (S180). Here, in a case where the value of the counter N is not 20 (in a case of NO), the process returns to S110 and then the same process is repeated. On the other hand, in a case where the value of the counter N is 20 (in a case of YES), since the high temperature period t is ended, the counter N is set to the value of 0 (S190).

Next, as illustrated in FIG. 6, a control of switching the temperature of the heating resistor 27 to a low temperature side and maintaining the temperature of the heating resistor is performed (S200).

Next, it is determined whether or not 10 ms elapses after the temperature of the heating resistor 27 is changed to a low temperature side (S210). Here, in a case where 10 ms does not elapse (in a case of NO), the determination of S210 is repeatedly performed. On the other hand, in a case where it is determined that 10 ms elapsed (in a case of YES), a count-up process which increases the number of the counter N by one is performed (S220).

Next, a process of acquiring and storing the temperature voltage VT is performed (S230).

Next, it is determined whether or not the number of the acquired temperature voltages VT, for example, is ten (S240). Here, in a case where the number of the acquired temperature voltages VT is less than ten (in a case of NO), the process proceeds to S270. On the other hand, in a case where the number of the acquired temperature voltages VT is ten (in a case of YES), the maximum value and the minimum value (high possibility of noise) are removed from the acquired ten temperature voltages VT (S250).

Next, the temperature voltage average value VTav, which is an average of the eight temperature voltages VT, in which the maximum value and the minimum value are removed, is calculated and stored (S260).

Next, it is determined whether or not the value of the counter N is 11 or more (that is, whether or not it is timing of acquisition of low temperature voltage VL) (S270). Here, in a case where the value of the counter N is not 11 or more (in a case of NO), the process returns to S210 and then the same process is repeated. On the other hand, in a case where the value of the counter N is 11 or more (in a case of YES), a process of acquiring and storing the detection signal V1 output from the energization control circuit 31 as the low temperature voltage VL is performed (S280).

Next, it is determined whether or not the number of the acquired low temperature voltages VL, for example, is ten (S290). Here, in a case where the number of the acquired low temperature voltages VL is less than ten (in a case of NO), the process proceeds to S320. On the other hand, in a case where the number of the acquired low temperature voltages VL is ten (in a case of YES), the maximum value and the minimum value (high possibility of noise) are removed from the acquired ten low temperature voltages VL (S300).

Next, the voltage average value at low temperature VLav, which is an average of the eight low temperature voltages VL, in which the maximum value and the minimum value are removed, is calculated and stored (S310).

Next, it is determined whether or not the value of the counter N is 20 (that is, whether or not it is timing of end of low temperature period t) (S320). Here, in a case where the value of the counter N is not 20 (in a case of NO), the process returns to S210 and then the same process is repeated. On the other hand, in a case where the value of the counter N is 20 (in a case of YES), since the low temperature period t is ended, the counter N is set to the value of 0 (S330).

Next, a control temperature of the heating resistor 27 is changed to a high temperature side and the process returns to the process of the S110.

Accordingly, it is possible to obtain the voltage average value at high temperature VHav, the voltage average value at low temperature VLav, and a temperature voltage average value Vtav by the above-described calculation data acquisition process.

(Gas Density Calculating Process)

The gas density calculating process is a process of calculating the hydrogen gas density using the data obtained by the above-described calculation data acquisition process.

As illustrated in FIG. 7, when the gas density calculating process is started, first, a process of obtaining the voltage average value at high temperature VHav, the voltage average value at low temperature VLav, and the temperature voltage average value VTav, which are obtained and stored by the operating data acquisition process is performed in the operating unit 7 (S400).

Next, a determination process of whether or not the voltage average value at high temperature VHav, the voltage average value at low temperature VLav, and the temperature voltage average value VTav can be acquired is performed (S410). Here, in a case where it is determined that acquiring them is not possible (in a case of NO), the process is ended once.

On the other hand, in a case where it is determined that the voltage average value at high temperature VHav, the voltage average value at low temperature VLav, and the temperature voltage average value VTav can be acquired (in a case of YES), a voltage ratio VC is calculated based on the voltage average value at high temperature VHav, the voltage average value at low temperature VLav, and Equation 1 (S420).

VC=VHav/VLav (1)

In addition, in parallel with the operation process, the gas density X in the temperature voltage average value VTav (that is, environmental temperature T) and the voltage ratio VC (0) when the humidity H is zero are calculated based on the temperature voltage average value VTav and the voltage conversion ratio map data (S430).

Next, a voltage ratio difference ΔVC in the temperature voltage average value VTav is calculated by setting the voltage ratio VC calculated in S420 and the voltage ratio VC (0) in S430 as the input values of following Equation (2) (S440).

ΔVC=VC−VC (0) (2)

Next, the humidity H during the voltage ratio difference ΔVC is calculated based on the voltage ratio difference ΔVC calculated in S440 and the humidity conversion map data (S450).

In addition, in parallel to calculating the humidity H, the gas density X in the temperature voltage average value VTav (that is, environmental temperature T) and the high temperature voltage VH (0) when the humidity H is zero is calculated based on the voltage average value at high temperature VHav, temperature voltage average value VTav, and the voltage conversion map data at high temperature (S460).

Next, the voltage change at high temperature ΔVH (H) representing a voltage variation due to the humidity H of the voltage average value at high temperature VHav is calculated based on the voltage average value at high temperature VHav obtained in S410, the humidity H calculated in S450, and the humidity change in voltage conversion map data (S470).

Next, a voltage change at high temperature ΔVH (G) representing the voltage variation due to the combustible gas of the voltage average value at high temperature VHav is calculated by setting the voltage average value at high temperature VHav obtained in S410, the high temperature voltage VH (0) calculated in S460, and the voltage change at high temperature ΔVH (H) calculated in S470 as the input values of following Equation (3) (S480).

ΔVH (G)=VHav−VH (0)−ΔVH (H) (3)

In addition, in parallel to calculating the voltage change at high temperature ΔVH (G), a gas sensitivity G (VT) representing the pre-set sensitivity (unit is reciprocal number of gas density X) with respect to the combustible gas for each temperature voltage average value VTav with regard to the voltage average value at high temperature VHav is calculated based on the voltage average value at high temperature VHav, the temperature voltage average value VTav and the gas sensitivity conversion map data which are acquired in S410 and the gas sensitivity conversion map data (S490).

Lastly, the gas density X of the combustible gas (hydrogen) is calculated by setting the voltage change at high temperature ΔVH (G) calculated in S480 and the gas sensitivity G (VT) calculated in S490 to the input values of following Equation (4) (S500).

x=ΔVH (G)/G(VT) (4)

Then, when the gas density X is calculated, the process returns to the S400 and then the above-described process is repeatedly performed.

Moreover, in the present embodiment, description will be given by adapting an example in which the first set temperature CH is set to 400° C. and the second preset temperature CL is set to 300° C. For this reason, a voltage, which corresponds to 400° C., across the heating resistor 27 is set to the high temperature voltage VH and a voltage, which corresponds to 300° C., across the heating resistor 27 is set to the low temperature voltage VL. It is possible to ensure high resolution in a ratio of the high temperature voltage VH and the low temperature voltage VL by setting the difference (set temperature difference) between the first set temperature CH and the second set temperature CL to 100° C. In order to ensure the high resolution in the ratio of the high temperature voltage VH and the low temperature voltage VL, the set temperature difference is set to 50° C. or more. This is because it is necessary to accurately calculate the humidity H of the atmosphere.

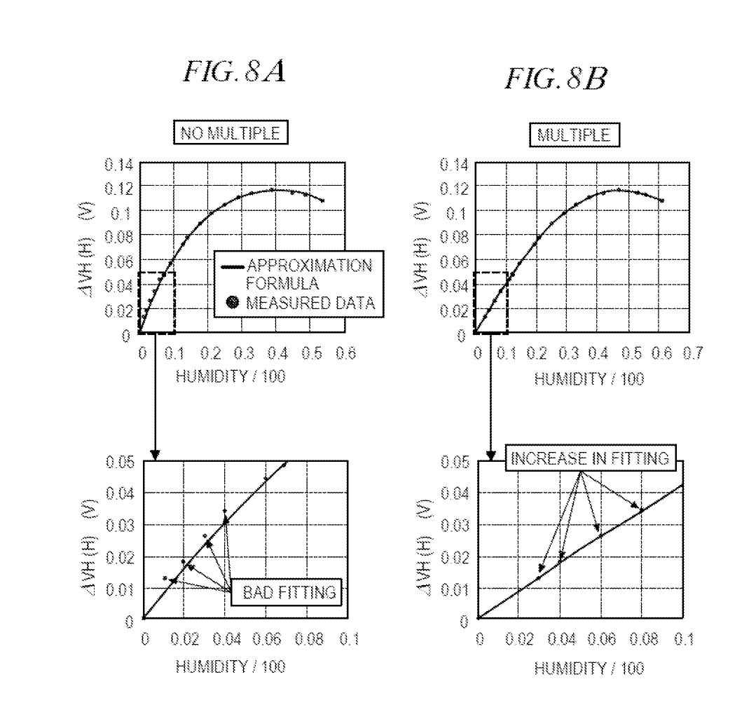

In addition, a humidity change in voltage conversion map data used during the above-described gas density calculating process, as illustrated in FIG. 8, in which a horizontal axis is set to a value obtained by dividing humidity (volume %) by 100 and a vertical axis is set to ΔVH (H), is a formula (temperature change in voltage conversion approximation formula) obtained from a graph plotting the measured data. However, if a scale of the horizontal axis is unchangedly used and approximated, in particular, since a fitting in a low temperature side leads to a bad error (refer to FIG. 8A), an approximation formula is obtained (refer to FIG. 8B) using a multiple (here, for example, 0.8 times). Therefore, as the approximation formula in the low temperature side and the fitting of the measured data increase, calculation accuracy increases. Moreover, lower figures of FIGS. 8A and 8B are the figures which enlarge the frameworks of upper figures of FIGS. 8A and 8B.

d) Next, description will be given to the effect of the present embodiment.

In the present embodiment, among of a pair of high temperature period t and the low temperature period t, the heating resistor voltage is respectively acquired a plurality of times in each target period t/2 after a predetermined waiting time t/2 elapses from the switching start to each period at predetermined time intervals (e.g., 10 ms) shorter than each of the target period t/2.

Then, an average value (voltage average value at high temperature VHav) of the heating resistor voltage acquired the number of times (e.g., eight times) in which the maximum value and the minimum value are removed is obtained using the heating resistor voltage obtained a plurality of times (e.g., ten times) in the target period t/2 of the high temperature period t, and the voltage average value at high temperature VHav is used to calculate the density of the hydrogen gas.

In the same manner, an average value (voltage average value at low temperature VLav) of the resistor heater voltage acquired the number of times (e.g., eight times) in which the maximum value and the minimum value are excluded is obtained using the heating resistor voltage acquired a plurality of times (e.g., ten times) in the target period t/2 of the low temperature period t, and the voltage average value at low temperature VLav is used to calculate the density of the hydrogen gas.

In other words, in this embodiment, an average value of the measured value of the heating resistor voltages acquired a plurality of times is used as the heating resistor voltage in the target period t/2 of the high temperature period t and the target period t/2 of the low temperature period t which are used in the calculation of the density of the hydrogen gas. However, at that time, an average value in which the maximum value and the minimum value are excluded is used.

Thus, since it is possible to reduce the impact, which is with respect to the heating resistor 27, of the fluctuation of the heating resistor voltage due to the switch of the control to the high temperature side or the low temperature side and it is possible to reduce the impact of the noise, the detection accuracy of the hydrogen gas density can be increased.

In addition, in the present embodiment, the temperature voltage corresponding to the resistance value of the temperature measuring resistor 29 is acquired a plurality of times during the waiting time t/2 of the low temperature period t, an average value (temperature voltage average value VTav) in which the maximum value and the minimum value of the plurality times of the temperature voltage are excluded is obtained, and then the temperature voltage average value VTav is used to calculate the density of hydrogen gas.

Therefore, the impact of the noise on the temperature voltage can be reduced. In addition, since the temperature voltage is acquired during the different waiting times t/2 different form the above-described (voltage of heating resistor 29 is acquired) target period t/2, there is an advantage that a burden of calculation is not excessively concentrated.

Furthermore, the present invention is not limited to the embodiment and can be implemented in various aspects without departing from the concept of the present invention.

(1) For example, in the embodiment, the maximum value and the minimum value are excluded from a plurality of data acquired, however, other data in addition to the maximum value and the minimum value may be excluded. For example, values of two or more, which decreases in order from the maximum value, may be excluded and values of two or more, which increases in order from the minimum value may be excluded.

(2) In addition, in the embodiment, an average value is obtained by acquiring the temperature voltage a plurality of times by excluding the maximum value and the minimum value during the waiting time of low temperature period, however, the average value may be obtained by acquiring the temperature voltage a plurality of times during the waiting time of high temperature period. Alternatively, the average value may be obtained in the same manner during the period in both the high temperature period and the low-temperature period.

What is claimed is:

1. A gas detection apparatus comprising:
a heating resistor which is disposed in an atmosphere and of which a resistance value changes due to change in temperature of the heating resistor;
an energization control unit which alternately switches, by controlling switching an energization state to the heating resistor at a predetermined cycle, a temperature of the heating resistor to two different temperatures of a high temperature side and a low temperature side which are set in advance;
a processor; and
a memory storing computer readable instructions, when executed by the processor, causing the gas detection apparatus to:
calculate a density of combustible gas contained in the atmosphere using a heating resistor voltage between terminals of the heating resistor in a high temperature period which is controlled to the high temperature side and a heating resistor voltage between terminals of the heating resistor in a low temperature period which is controlled to the low temperature side;
acquire three or more values of the heating resistor voltage in each target period after a predetermined waiting time elapses since the energization control unit switches each period of the high temperature period and the low temperature period, the three or more values of the heating resistor voltage are acquired at an interval shorter than the target period;
obtain a first average value of the values, from which a maximum value and a minimum value are excluded, of the heating resistor voltage obtained in the target period of the high temperature period;
obtain a second average value of the values, from which a maximum value and a minimum value are excluded, of the heating resistor voltage obtained in the target period of the low temperature period; and
use the first and second average values for a calculation of density of the combustible gas.

2. The gas detection apparatus according to claim 1, wherein
four or more values of the heating resistor voltage are acquired in the target period of the high temperature period, and
four or more values of the heating resistor voltage are acquired in the target period of the low temperature period respectively.

3. The gas detection apparatus according to claim 1, further comprising a temperature measuring resistor of which a resistance value changes according to changes of an environmental temperature which is a temperature of the atmosphere,
wherein the computer readable instructions, when executed by the processor, further causes the gas detection apparatus to:
calculate the density of the combustible gas based on the environmental temperature, which is obtained from the resistance value of the temperature measuring resistor during the calculation of the density of the combustible gas, and the first and second average values;
acquire three or more values corresponding to the resistance value of the temperature measuring resistor during at least one of the waiting time of the high temperature period and the waiting time of the low temperature period;
obtain a third average value of the values, from which a maximum value and a minimum value are excluded, of the temperature measuring resistor;
set the third average value corresponding to the resistance value of the temperature measuring resistor which is used for the calculation of the density of the combustible gas.

4. A gas detection method in which a gas detection apparatus including a heating resistor which is disposed in an atmosphere and of which a resistance value changes due to change in temperature of the heating resistor is used, the method comprising:
alternately switching, by controlling switching an energization state to the heating resistor at a predetermined cycle, a temperature of the heating resistor to two different temperatures of a high temperature side and a low temperature side which are set in advance;
calculating a density of combustible gas contained in the atmosphere using heating resistor voltage between terminals of the heating resistor in a high temperature period which is controlled to the high temperature side and a heating resistor voltage between terminals of the heating resistor in a low temperature period which is controlled to the low temperature side;
acquiring three or more values of the heating resistor voltage in each target period after a predetermined waiting time elapses since the energization control unit switches each period of the high temperature period and the low temperature period, the three or more values of the heating resistor voltage are acquired at an interval shorter than the target period; and
obtaining a first average value of the values, from which a maximum value and a minimum value are excluded, of the heating resistor voltage obtained in the target period of the high temperature period;
obtaining a second average value of the values, from which a maximum value and a minimum value are excluded, of the heating resistor voltage obtained in the target period of the low temperature period; and
using the first and second average values for a calculation of density of the combustible gas.

5. The gas detection method according to claim 4,
four or more values of the heating resistor voltage are acquired in the target period of the high temperature period, and
four or more values of the heating resistor voltage are acquired in the target period of the low temperature period respectively.

6. The gas detection method according to claim 4, wherein
the density of the combustible gas is calculated based on an environmental temperature, which is obtained from a resistance value of a temperature measuring resistor during the calculation of the density of the combustible gas, and the first and second average values, the resistance value of the temperature measuring resistor changing according to changes of the environmental temperature;
three or more values corresponding to the resistance value of the temperature measuring resistor are acquired during at least one of the waiting time of the high temperature period and the waiting time of the low temperature period;
a third average value of the values, from which a maximum value and a minimum value are excluded, of the temperature measuring resistor is obtained;
the third average value is set corresponding to the resistance value of the temperature measuring resistor which is used for the calculation of the density of the combustible gas.
